(19) United States
(12) Patent Application Publication
(10) Pub. No.: US 2013/0080354 A1
(43) Pub. Date: Mar. 28, 2013

(54) METHODS AND APPARATUS RELATED TO BILLING AND ACCOUNTING FOR ASSETS THAT REQUIRE MORE THAN TWO FACTORS TO ESTABLISH ASSET VALUE

(71) Applicant: Jeff Stollman, Chesterbrook, PA (US)

(72) Inventor: Jeff Stollman, Chesterbrook, PA (US)

(21) Appl. No.: 13/627,543

(22) Filed: Sep. 26, 2012

Related U.S. Application Data
(63) Continuation-in-part of application No. 13/245,023, filed on Sep. 26, 2011, now Pat. No. 8,296,214.

(51) Int. Cl. G06Q 30/02

(52) U.S. Cl. 705/36 R

(57) ABSTRACT

A non-transitory processor-readable medium includes code to cause a processor to receive a signal associated with a quantity of an asset at a first time, having a value of an underlying index at the first time. The processor executes code to re-index the underlying index at the first time to a predetermined value to produce a re-indexed value at the first time. The processor executes code to calculate a value of the asset at a second time, after the first time, based at least in part on the re-indexed value at the second time and an adjustment value. The adjustment value based on the re-indexed value at the first time, the re-indexed value at the second time, and a multiplier. The processor executes code to send, to a requesting entity, the value of the asset at the second time.

### CROSS-REFERENCE TO RELATED APPLICATION

This application is a continuation-in-part of and claims priority to U.S. patent application Ser. No. 13/245,023, filed Sep. 26, 2011, entitled “Methods and Apparatus Related to Billing and Accounting for Assets that Require More Than Two Factors to Establish Asset Value,” the disclosure of which is hereby incorporated by reference in its entirety.

### BACKGROUND

Some embodiments described herein relate generally to outputting asset values, and more particularly to methods and apparatus for determining and outputting price and transaction values for an index multiplier fund.

Many known accounting systems are limited to a single model for establishing the value (V) of an asset: price times quantity (P*Q). While this model is broadly applicable and effective, it fails to account for additional complexity inherent in many real-world asset valuation methods. For example, the value of produce is a function not only of price times quantity, but also of time. Because fruit is often picked before it is ripe, its price may increase over time as it ripens. Thus, the value of a given amount of fruit is better expressed using a modified P*Q model, where P=F(t), and t is the variable time. In this example, the pricing value function F(t) starts low, rises over time to peak ripeness, then declines to zero as the value of the produce declines to a complete write-off as spoilage occurs. Thus, a more-accurate valuation model for fruit can be expressed as V=F(t)*Q, where F(t) is the unit price of the fruit at a given time t (with the quantity of fruit, Q, being constant throughout the maturation process).

In addition, the value of some assets can change as a function of value-add that takes place during the production, manufacturing and/or distribution processes. These processes can also alter the quantity of the asset. For example, the value of the inventory of a lumber mill may increase, and the quantity decrease, as lumber is transformed from board feet to finished roof trusses or moldings. Thus, in an appropriate modified P*Q model, price (P)=F(stage) and quantity (Q)=F₂(stage), where stage represents a step function related to the stage in the transformation of the lumber into the finished product. Typically, in this processing, P increases from stage to stage, while Q decreases or has its metric completely transformed (e.g., from board feet to linear feet for a molding). Using this modified method of determining P and Q, a modified valuation model for lumber can be expressed V=F(stage)*F₂(stage).

In investing, the growth of index funds (such as Exchange Traded Funds, or “ETFs”) has been followed by an expansion in aggressive, leveraged funds based on an underlying index fund. The daily change in price of these “multiplier funds” is a multiple of the daily percentage change of the underlying index on which the multiplier fund is based. While on an intra-day and daily basis these multiplier funds closely mirror the performance of the underlying index, the nature of the P*Q pricing mechanism causes such funds to lose fidelity with the underlying index over time. This loss of fidelity is caused by the natural changes in direction (e.g., from rising to falling or vice-versa) in the daily closing value of the underlying index, which create a divergence between the multiplier fund and the underlying index. This divergence means that an investor may incur a loss in the sale of a multiplier fund even though its underlying index is equal to or higher than the value point at which the multiplier fund was purchased. Over time these daily index fluctuations manifest multiple changes in “direction” (i.e., from gain to loss or loss to gain), which can cause this performance gap to continually grow. While many investors in aggressive multiplier funds are day-traders who remain unaffected by this divergence (since it only arises over time), such funds can impose a significant penalty on positions taken over a longer duration.

Thus, a standard two-variable P*Q value model for a multiplier fund does not provide sufficient degrees of freedom to track the value of produce over time, to track the value of inputs being transformed, or to both accurately track daily percentage changes in an underlying index fund and maintain fidelity therewith. As such, a need exists for methods and apparatus that utilize a multi-variable method to value a multiplier fund, thereby exploiting its inherent aggressiveness without incurring the above-described performance gap. These methods can also be applied to other valuation problems such as produce and milled lumber in order to provide current dynamic inventory, rather than a periodic (e.g., quarterly) estimate or hard count.

### SUMMARY

Methods and apparatus described herein relate to determining and outputting price and transaction values for an index multiplier fund. In some embodiments, a non-transitory processor-readable medium includes code to cause a processor to receive a signal associated with a quantity of an asset at a first time. The asset has a value of an underlying index at the first time. The non-transitory processor-readable medium includes code to re-index the value of the underlying index at the first time to a predetermined value to produce a re-indexed value of the underlying index at the first time. The non-transitory processor-readable medium includes code to calculate a value of the asset at a second time, after the first time, based at least in part on the re-indexed value of the underlying index at the second time and an adjustment value. The adjustment value is based at least in part on the re-indexed value of the underlying index at the first time, the re-indexed value of the underlying index at the second time, and a multiplier. The non-transitory processor-readable medium includes code to cause a processor to send, to a requesting entity, the value of the asset at the second time.

### BRIEF DESCRIPTION OF THE DRAWINGS

FIG. 1 is a schematic illustration of a multiplier fund valuation system, according to an embodiment.

FIG. 2 is a system block diagram of a peripheral device of a multiplier fund valuation system, according to an embodiment.

FIG. 3 is a system block diagram of a valuation server of a multiplier fund valuation system, according to an embodiment.

FIG. 4 is a flow chart illustrating a method of determining and outputting a current value of a number of shares of a multiplier fund based on an adjustment value, according to an embodiment.

FIG. 5 is a time-series value chart illustrating the relationship of a 2× multiplier fund to its associated underlying index over a twenty trading day period, with the price of the 2× multiplier fund being calculated without an adjustment value.

FIG. 6 is a time-series value chart illustrating the relationship between an index, a first, traditional 2× multiplier fund based on the index and a second 2× multiplier fund based on the index, the price of which is calculated using an adjustment value, according to an embodiment.

FIG. 7 is a table illustrating sample closing values of an underlying index, the corresponding value Φ for a 2× multiplier fund and the share price of the 2× multiplier fund based on the underlying index, according to an embodiment.

FIG. 8 is a table illustrating examples of opening transactions and closing transactions associated with a fund, according to an embodiment.

FIG. 9 is a table illustrating examples of opening transactions and closing transactions associated with a fund, according to an embodiment.

### DETAILED DESCRIPTION

In some embodiments, a valuation system can include a valuation server operatively coupled to one or more peripheral devices via a network. The valuation server can include, for example, one or more hardware-based and/or software-based modules configured to determine a value of a multiplier fund based on an underlying index and/or the value of a portfolio of one or more assets, the value of at least one of which is based on the multiplier fund. In some embodiments, the valuation server can receive information associated with the underlying index, such as a current, previous, historical and/or predicted future values of the underlying index. The valuation server can also optionally receive an asset value or quantity, such as a quantity of shares of the multiplier fund.

Based at least in part on the received information, the valuation server can determine a current unit price of the multiplier fund. The valuation server can determine the current unit price based on a current price/value of the underlying index and an adjustment value Φ. The adjustment value Φ can be determined based at least in part on a previous price/value of the underlying index, the current price/value of the underlying index and a multiplier value associated with the multiplier fund. Based on the current unit price/value of the multiplier fund, the valuation server can next determine a value of an asset based on the multiplier fund, such as a quantity of shares of the multiplier fund. For example, the valuation server can determine a product of the quantity of shares of the multiplier fund and the current price/value of the multiplier fund to determine an overall value of the quantity of shares.

Having determined the current value of the multiplier fund and/or an asset based thereon, the valuation server can define one or more signals including the determined information. The valuation server can next send the one or more signals to one or more peripheral devices, via a network. The network can be, for example, a local area network (LAN), wide area network (WAN) or the Internet. In some embodiments, the one or more signals can be received by one or more peripheral devices, such as a personal computer, a tablet computing device and/or a mobile computing device, such as a smartphone.

Upon receipt of the one or more signals, any of the peripheral devices can output one or more pieces of information. For example, a mobile peripheral device can output at a display the current price/value of the multiplier fund, along with a current value of a quantity of shares thereof. In another example, a personal computing device can output, via a speaker, one or more audio signals or sounds relaying a current, historical and/or predicted value of the underlying index and/or the multiplier fund. In another example, a tablet computing device can output, at a display of the tablet computing device, a chart and/or graph indicating the price/value of the multiplier fund and/or the underlying index over a predetermined and/or configurable period of time.

In some embodiments, a non-transitory processor-readable medium includes code to cause a processor to receive a signal associated with a quantity of an asset at a first time. The asset has a value of an underlying index at the first time. The non-transitory processor-readable medium includes code to re-index the value of the underlying index at the first time to a predetermined value to produce a re-indexed value of the underlying index at the first time. The non-transitory processor-readable medium includes code to calculate a value of the asset at a second time, after the first time, based at least in part on the re-indexed value of the underlying index at the second time and an adjustment value. The adjustment value is based at least in part on the re-indexed value of the underlying index at the first time, the re-indexed value of the underlying index at the second time, and a multiplier. The non-transitory processor-readable medium includes code to cause a processor to send, to a requesting entity, the value of the asset at the second time.

In some embodiments, a method includes receiving, at a processor, a signal associated with an opening transaction (e.g., purchase or sale) of a quantity of an asset at a first time. The asset has a value related to an underlying index at the first time. The method includes calculating a value of the asset at a second time, after the first time, based at least in part on a value of the underlying index at the second time and an adjustment value. The adjustment value is based at least in part on the value of the underlying index at the first time, the value of the underlying index at the second time, and a multiplier. The method further includes sending, to a requesting entity, the value of the asset at the second time.

In some embodiments, a method includes receiving, at a processor, a signal associated with a quantity of a first asset at a first time. The first asset has a value based on an underlying index at the first time. The method further includes receiving a signal associated with a value of a second asset at the first time. The value of the second asset at the first time is configured to mirror the exposure of the first asset at the first time. The method includes calculating an adjustment value based at least in part on the value of the underlying index at the first time, the value of the underlying index at a second time, before the first time, and a multiplier. The method includes calculating a quantity of the second asset at a third time, after the first time. The quantity of the second asset at the third time is based at least in part on the quantity of the second asset at the first time and the adjustment value at the first time. The method further includes sending, to a requesting entity, the quantity of the second asset at the third time.

As used in this specification, the term “fund” refers to a collective investment scheme such as, for example, a mutual fund, an exchange traded fund (ETF), an investment fund, or the like. Furthermore, the embodiments described herein refer to funds with a value at least partially associated with an index. For example, an ETF can be configured to substantially track a value of an underlying index.

As used herein, the terms “underlying index” and “index” refer to any discoverable or calculable value that can be associated with a value of an asset or a group of assets. For example, the Dow Jones Industrial Average, the S&P 500, and the NASDAQ 100 are examples of an underlying index with which the value of a fund (described above) can be associated.

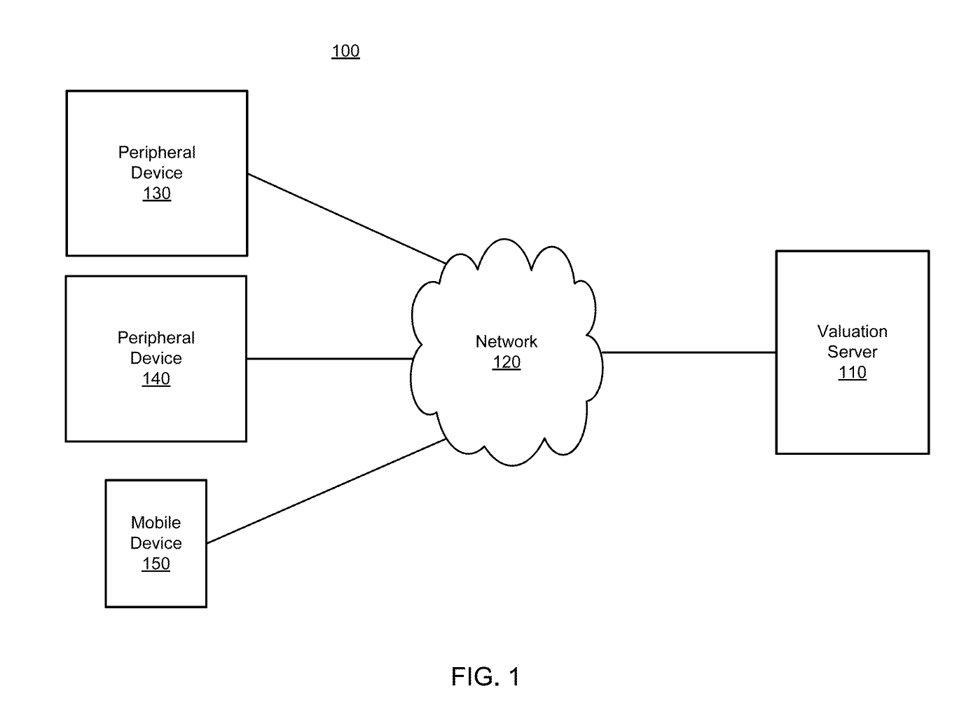

FIG. 1 is a schematic illustration of a multiplier fund valuation system 100, according to an embodiment. More specifically, FIG. 1 illustrates a multiplier fund valuation system 100 that includes a valuation server 110 in communication with a first peripheral device 130, a second peripheral device 140 and a mobile device 150, via a network 120. Although shown as including a single valuation server, a single network, two peripheral devices and a single mobile device, in some embodiments, the multiplier fund valuation system 100 can include multiple valuation servers, multiple networks and any number of peripheral devices and/or mobile devices.

The valuation server 110 can be any combination of hardware and/or software (executing in hardware) configured to determine a current and/or historical values of a multiplier fund based on a current and/or historical values of an underlying index. The valuation server 110 can be further configured to determine a current, historical and/or predicted future values of one or more assets based on the multiplier fund, such as a quantity of shares of the multiplier fund. For example, the valuation server 110 can be a computing device, such as a server or personal computing device (e.g., a rack-mounted or other server, a desktop, laptop, notebook, etc.). The valuation server 110 can optionally include one or more hardware and/or software modules configured to receive information associated with a value of an index or other fund and determine a value of one or more multiplier funds based on that index. As shown in FIG. 1, the valuation server 110 can be physically and/or operatively coupled to the peripheral device 130, a peripheral device 140 and a mobile device 150, via a network 120.

In some embodiments, the valuation server 110 can be coupled to the network 120 via a wireless and/or wired data connection, such as a connection based on one or more of the Institute of Electrical and Electronics Engineers (IEEE) 802.x standards (e.g., IEEE 802.3 Ethernet, 802.11 wireless LAN, 802.16 WiMAX). Alternatively, in some embodiments, the valuation server 110 can be coupled to the network 120 via hardware and/or software based on one or more short-range connection standards, such as Bluetooth, wireless Universal Serial Bus (USB), Ultra-wideband (UWB), Radio-frequency identification (RFID), etc. In some embodiments, the valuation server 110 can be operatively and/or physically coupled to one or more other networks or devices (not shown in FIG. 1), from which it can be configured to receive information associated with the current and/or historical value of an underlying index, brokerage account information, and the like.

The network 120 can be any computer network configured to receive and send information between each or any of the first peripheral device 130, the second peripheral device 140, the mobile device 150 and the valuation server 110. The network 120 can include one or more computer devices, such as switching, routing, storage and/or other devices. In some embodiments, the network 120 can be a local area network (LAN), wide area network (WAN), organization intranet, or the Internet.

The peripheral devices 130 and 140 can each be any network-enabled computing device capable of exchanging and outputting information in textual, audio and/or graphical form (or storing the data for later output to such a peripheral device). For example, either or both of the peripheral devices 130 and 140 can be a client computing device, such as a personal computer, tablet computing device, or other desktop or mobile computing device. As shown in FIG. 1, each of the first peripheral device 130 and the second peripheral device 140 is operatively coupled to the network 120, and in communication with the valuation server 110 via the network 120. More specifically, each of the first peripheral device 130 and the second peripheral device 140 can be operatively coupled to the network 120 via one or more wireless and/or wired connections and/or protocols. For example, in some embodiments, the first peripheral device 130 can be operatively coupled to the network 120 via a wireless network module (e.g., a wireless Ethernet network interface card (“NIC”)) and/or a wired network module (e.g., a wired Ethernet NIC and/or a Fibre Channel host bus adapter (“HBA”) or converged network adapter (“CNA”). In some embodiments, the first peripheral device 130 and/or the second peripheral device 140 can be operatively coupled to the network 120 via a modem, such as a modem configured to exchange information via a standard telephone line. In some embodiments, either or both of the peripheral devices 130 and 140 can be physically and/or operatively coupled to one or more output devices, such as a speaker, monitor, projector, television, printer, tactile feedback device, or other display and/or output device.

The mobile device 150 can be any mobile computing device capable of exchanging information with the valuation server 110 via the network 120. For example, the mobile device 150 can be a cellular telephone (e.g., a smartphone), a personal digital assistant (PDA), a tablet computing device, or other portable computing and/or communications device. The mobile device 150 can be operatively coupled to the network 120 via, for example a cellular- and/or Internet Protocol (IP)-based network, such as an Enhanced Data Rates for GSM Evolution (EDGE), Global System for Mobile (GSM), Code division multiple access (CDMA), Time division multiple access (TDMA), Long Term Evolution (LTE), or other network. In some embodiments, the mobile device 150 can include one or more hardware and/or software modules (executing in hardware) configured to exchange information via the network 120 on behalf of the mobile device 150. The mobile device 150 can also optionally include and/or be coupled to one or more output devices and/or modules, such as a display screen, speaker, tactile feedback device or other output device.

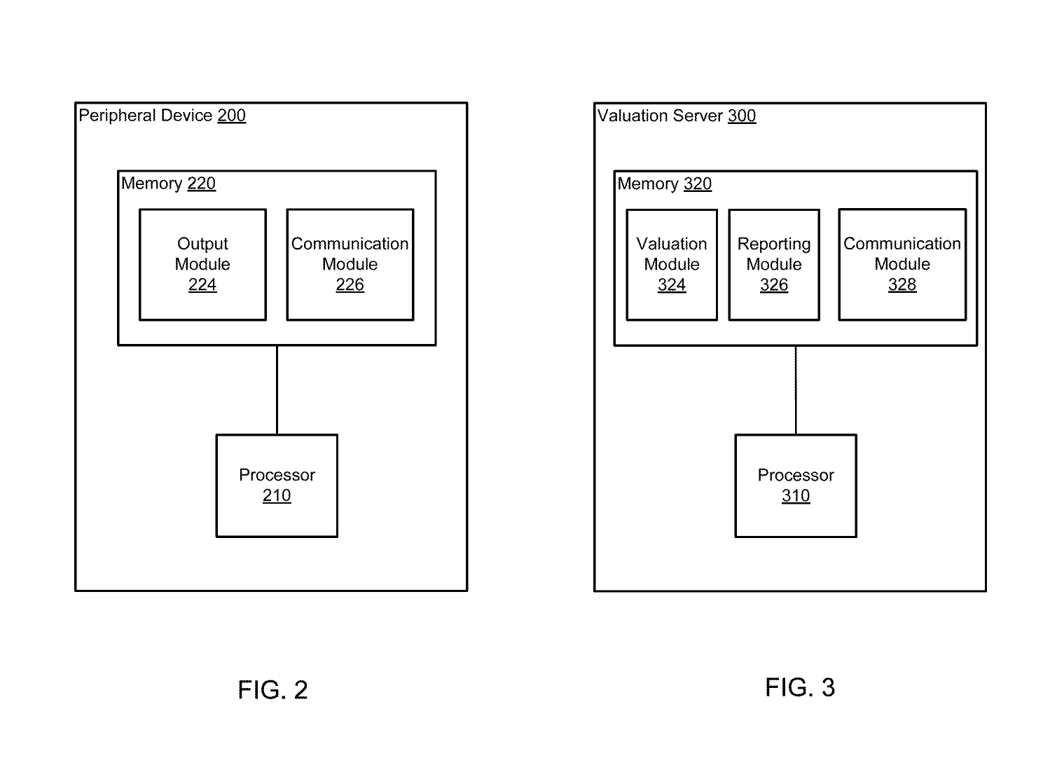

FIG. 2 is a system block diagram of a peripheral device of a multiplier fund valuation system, according to an embodiment. More specifically, FIG. 2 is a system block diagram of a peripheral device 200, similar to the first peripheral device 130 and/or the second peripheral device 140 described in connection with FIG. 1 above. The peripheral device 200 includes a processor 210 and a memory 220. The memory 220 includes an output module 224 and a communication module 226. The processor 210 is operatively coupled to the memory 220.

The processor 210 can be a general-purpose processor (e.g., a central processing unit (CPU)) or other processor configured to execute one or more instructions. In some embodiments, the processor 210 can alternatively be an application-specific integrated circuit (ASIC) or a field programmable gate array (FPGA). The memory 220 can be any fixed or removable memory, such as a Random Access Memory (RAM), Read Only Memory (ROM), a hard disk drive, a solid-state drive (SSD), an optical drive, a flash memory drive, and/or other removable media.

The output module 224 can be a hardware-based and/or software-based module (executing in hardware) configured to output data. For example, the output module 224 can be a hardware module (e.g., a graphics card) operatively coupled to a software module (e.g., a video driver). In the example, the output module 224 can be operatively and/or physically coupled to a visual display device, such as a monitor, television, projector, printer, or other display screen or device. In some embodiments, the output module 224 can be a hardware and/or software module configured to output an audio or tactile output representing data and/or media. In some embodiments, the output module 224 can be configured to output any combination of audio, video, graphical, or tactile feedback and/or output. More specifically, the output module 224 can be configured to output information associated with a current, historical and/or predicted future value or values of a multiplier fund and/or an index on which the multiplier fund is based. In some embodiments, the output module 224 can do so in response to one or more messages, data frames, data packets and/or other information received from another device, such as a valuation server (such as the valuation server 110 of FIG. 1). In some embodiments, the output module 224 can be configured to output information associated with current, historical and/or predicted future value or values of one or more assets based on the multiplier fund, such as a quantity of shares of the multiplier fund or other asset. In some embodiments, the output module 224 can be configured to display any of the above-described information as a chart, graph, animation, or other graphical figure or resource.

The communication module 226 can be a hardware-based and/or software-based module (executing in hardware) configured to exchange information with one or more other devices or modules. More specifically, the communication module 226 can include one or more network communication cards, drivers and/or other hardware and/or software modules configured to send information to and/or receive information from a network and/or one or more server or client devices. Thus, in some embodiments, the communication module 226 can send, to a valuation server (via a network, e.g. the network 120 of FIG. 1) one or more requests for information associated with a multiplier fund, a related index and/or an asset based on the multiplier fund. In such embodiments, the communication module 226 can also receive the requested information and/or send the same for output by the output module 224.

FIG. 3 is a system block diagram of a valuation server of a multiplier fund valuation system, according to an embodiment. More specifically, FIG. 3 is a system block diagram of a valuation server 300, similar to the valuation server 110 described above with reference to FIG. 1. The valuation server 300 includes a processor 310 and a memory 320. The memory 320 includes a valuation module 324, a reporting module 326 and a communication module 328. The processor 310 is operatively coupled to the memory 320.

The processor 310 can be a general-purpose processor or other processor configured to execute one or more instructions. In some embodiments, the processor 310 can alternatively be an application-specific integrated circuit (ASIC) or a field programmable gate array (FPGA). The memory 320 can be any fixed or removable memory, such as a Random Access Memory (RAM), Read Only Memory (ROM), a hard disk drive, a solid-state drive (SSD), an optical drive, a flash memory drive, and/or other removable media.

The valuation module 324 can be any hardware-based module and/or software-based module configured to determine a value (such as a current, historical, or predicted future value or values) for one or more multiplier funds based on one or more underlying indices. The valuation module 324 can also be configured to determine a value (such as a current, historical, or predicted future value or values) for one or more assets based on the multiplier funds, such as a quantity of shares of the multiplier fund. In some embodiments, the valuation module 324 can optionally be configured to re-index the current, historical, or predicted future value or values for the underlying index to a predetermined value, as further described herein.

In some embodiments, the valuation module 324 can be a circuit board including an ASIC and/or FPGA operatively configured to calculate the multiplier fund and/or asset value(s) described above. In some embodiments, the valuation module 324 can include one or more software modules configured to receive information from the communication module 328, such as current and/or historical values for an index. Based on the received index value(s), the valuation module 324 can determine appropriate and corresponding values of a multiplier fund based thereon and/or one or more assets based on the multiplier fund.

More specifically, the valuation module 324 can determine a value of a multiplier fund based at least in part on (1) a current value of the underlying index; (2) a previous value of the underlying index; (3) a multiplier of the multiplier fund (e.g., 2×, 3×, −2×, −1×, etc.); (4) and an adjustment value (referred to hereinafter as Φ). In some embodiments, to determine the value of Φ, the valuation module 324 can perform the following operation:

Φ=[PV_{Index}*(1+(((CV_{Index}−PV_{Index})*M)/100))]/CV_{Index}

where PV_{Index} represents the previous closing value of the underlying index, CV_{Index} represents the current value of the underlying index, M represents the multiplier for the multiplier fund and Φ represents the adjustment value. For example, if the previous closing value of the underlying index (and of the multiplier fund) is 100, the current value of the underlying index is 103 and the multiplier for the multiplier fund is 2, then Φ=[100*(1+(((103−100)*2)/100))]/103, which equals 1.0291.

The valuation module 324 can next determine a single share price/value for the multiplier fund by multiplying the current value of the underlying index by Φ (expressed V_{Fund}=CV_{Index}*Φ). In the example above, the share price V_{Fund} of the multiplier fund is 103*1.0291, which equals 106. Thus, inasmuch as the current share price (V_{Fund}) of the multiplier fund is 106, the previous share price of both the multiplier fund and the underlying index (PV_{Index}) is 100 and the current value of the index (CV_{Index}) is 103, the share price of the multiplier fund manifests exactly a two times (2×) change (i.e., a 6% change) compared to that of the underlying index (i.e., a 3% change). In this manner, the share price of the multiplier fund is split across two components (i.e., CV_{Index} and Φ), both of which can be tracked and reported along with the resulting multiplier fund share price. Having determined the share price (i.e., value) for the multiplier fund, the valuation module 324 can define and send, to the reporting module 326, one or more signals including the share price.

The reporting module 326 can be any hardware-based module and/or software-based module configured to send information associated with an index fund and/or an associated multiplier fund (based thereon). For example, the reporting module 326 can be a set of one or more software modules configured to receive information from the valuation module 324 and format the same for transmission to one or more requesting peripheral devices. Although not shown in FIG. 3, in some embodiments the valuation module 324 can request and receive historical and/or other value information for the underlying index and/or the multiplier fund from an external memory, such as a database. Based on the received information, the reporting module 326 can optionally define reporting information based on the underlying index and/or the multiplier fund. For example, the reporting module 326 can define one or more trend-based metrics, price predictions and/or charts, graphs, tables or other graphical representations configured to convey information associated with the underlying index and/or the multiplier fund. In some embodiments, the reporting module 326 can be configured to send the reporting information to the communication module 328 for transmission to the one or more requesting peripheral devices.

The communication module 328 can be a hardware-based and/or software-based module (executing in hardware) configured to exchange information with one or more other devices or modules. More specifically, the communication module 328 can include one or more network communication cards, drivers and/or other hardware and/or software modules configured to send information to and/or receive information from a network and/or one or more server or client devices. Thus, in some embodiments, the communication module 328 can send, to one or more peripheral devices (via a network, e.g. the network 120 of FIG. 1) one or more signals including information defined by the valuation module 324 and/or the reporting module 326.

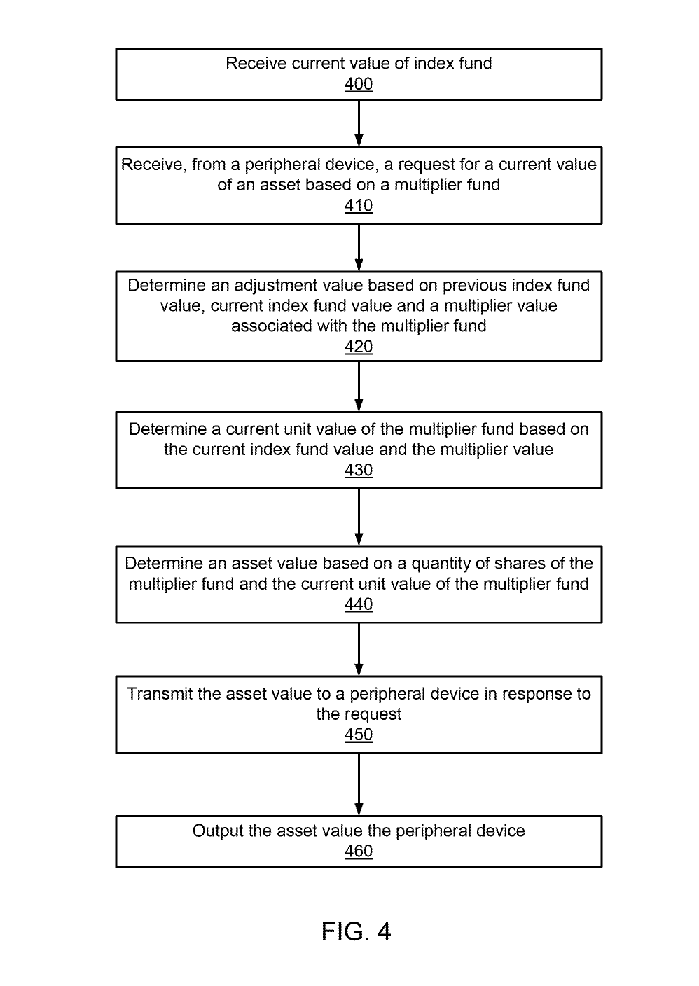

FIG. 4 is a flow chart illustrating a method of determining and outputting a current value of a number of shares of a multiplier fund based on an adjustment value, according to an embodiment. More specifically, a valuation server can receive a current value of an index, 400. The valuation server can be, for example, a hardware device configured to determine a current value of one of more multiplier funds based on their respective underlying index funds. In some embodiments, the valuation server can be operatively coupled to one or more peripheral devices (e.g., client computing devices) via a network, such as a LAN, a WAN and/or the Internet. In some embodiments, the valuation server can receive the current value of the index from another device, such as a server device. The server device can optionally be operatively and/or physically coupled to the valuation server via a network, such as a LAN, a WAN and/or the Internet.

The valuation server can receive, from a peripheral device, a request for a current value of an asset based on a multiplier fund, 410. In some embodiments, the multiplier fund can be based on the index, and the asset can be, for example, a number of shares of the multiplier fund. The valuation server can receive the request via a network, such as a LAN, a WAN or the Internet. In some embodiments, the request can be received from a client hardware and/or software module, such as a web browser. In such embodiments, the request can be formatted according to the Hypertext Transfer Protocol (HTTP) or other known protocol.

The valuation server can next determine an adjustment value based on a previous value of the index, the current value of the index and a multiplier value associated with the multiplier fund, 420. In some embodiments, in response to the received request, the valuation server can determine an adjustment value Φ based at least in part on the following equation:

Φ=[PV_{Index}*(1+(((CV_{Index}−PV_{Index})*M)/100))]/CV_{Index}

where PV_{Index} represents the previous closing value of the index, CV_{Index} represents the current value of the index, M represents the multiplier for the multiplier fund and Φ represents the adjustment value.

The valuation server can next determine a current unit value of the multiplier fund based on the current value of the index and the multiplier value, 430. Said differently, having determined the adjustment value Φ for the multiplier fund, the valuation server can determine a current unit value of the multiplier fund based on the following equation:

V_{Fund}=CV_{Index}*Φ

where CV_{Index} is the current value of the index, Φ is the adjustment value and V_{Fund} is the current unit value of the multiplier fund.

Based on the current unit value of the multiplier fund, the valuation server can determine an asset value based on a quantity of shares of the multiplier fund and the current unit value, 440. More specifically, the valuation server can multiply the current unit value of the multiplier fund by the quantity of shares to determine a total value of the quantity of shares of the multiplier fund. In some embodiments, the quantity of shares of the multiplier fund can be a quantity of shares currently held by an individual (e.g., an individual currently operating the requesting peripheral device).

Having determined the current asset value of the shares of the multiplier fund, the valuation server can define and send a signal including the current asset value to the requesting peripheral device, 450. The signal can also optionally include the current unit value of the multiplier fund, the quantity of shares of the multiplier fund, the current and previous values of the index, the value of Φ, etc. In some embodiments, the valuation server can send the signal to the requesting peripheral device via the network described in connection with step 410 above. In some embodiments, the valuation server can send the signal via a wired and/or wireless network connection, such as an Ethernet, wireless Ethernet, cellular network, Fibre Channel or other network connection. In some embodiments, the valuation server can send the signal on a periodic basis, such as hourly, daily, etc.

Upon receipt of the current asset value for the shares of the multiplier fund, the requesting peripheral device can output the current asset value, 460. For example, the requesting peripheral device can output the current asset value at a visual display (e.g., a monitor, a projector, etc.), via a speaker and/or via a tactile feedback device or mechanism. In some embodiments, the requesting peripheral device can output the value within a visual window, such as an operating system window associated with a currently-executing web browser application. If the received signal includes additional information (such as the current unit price of the multiplier fund, the quantity of shares of the multiplier fund, etc.), the requesting peripheral device can output any or all of this additional information.

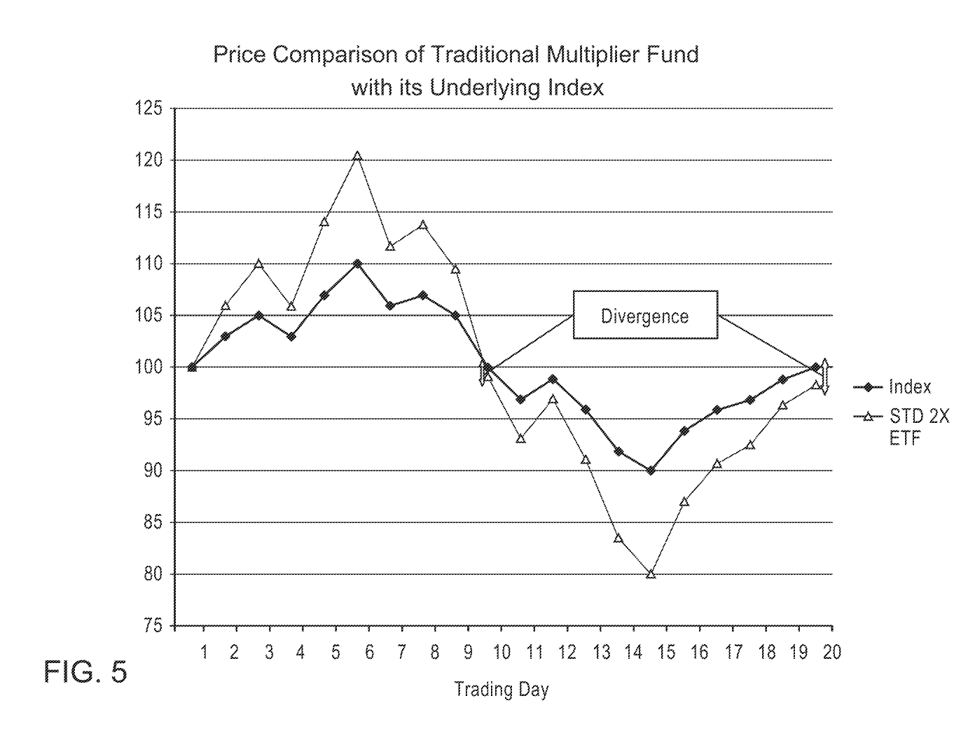

FIG. 5 is a time-series value chart illustrating the relationship of a 2× multiplier fund to its associated underlying index over a twenty trading day period, with the price of the 2× multiplier fund being calculated without an adjustment value. More specifically, FIG. 5 shows, for the twenty trading day period, both the prices of an example index and of an example multiplier fund whose daily percentage change is double the daily percentage change of the underlying example index. For example, if an investor purchases an exchange-traded fund (ETF) based on the underlying index on day 1, the investor pays 100 for the ETF (per the current underlying index price of 100). Ten days later, after the price of the underlying index has risen and subsequently dropped back to the original purchase price of 100, rather than also returning to its original purchase price of 100, the price of the multiplier fund is 99.19—nearly 1% less than its original purchase price. On day 20, after the price of the underlying index has further declined and subsequently risen and returned to the original purchase price, the price of the multiplier fund is at 98.44—reflecting a paper loss of 1.5%, even though there has been no net change in the underlying index price. Said differently, even though the underlying index price is unchanged, if an investor were to sell at this point, he/she would realize a loss. This divergence continues to increase as long as the underlying index does not make a sustained and dramatic move in any one direction. Only when the underlying index begins a steady and dramatic move upwards would an investor overcome this negative divergence and exploit the benefits of the aggressive 2× multiplier fund.

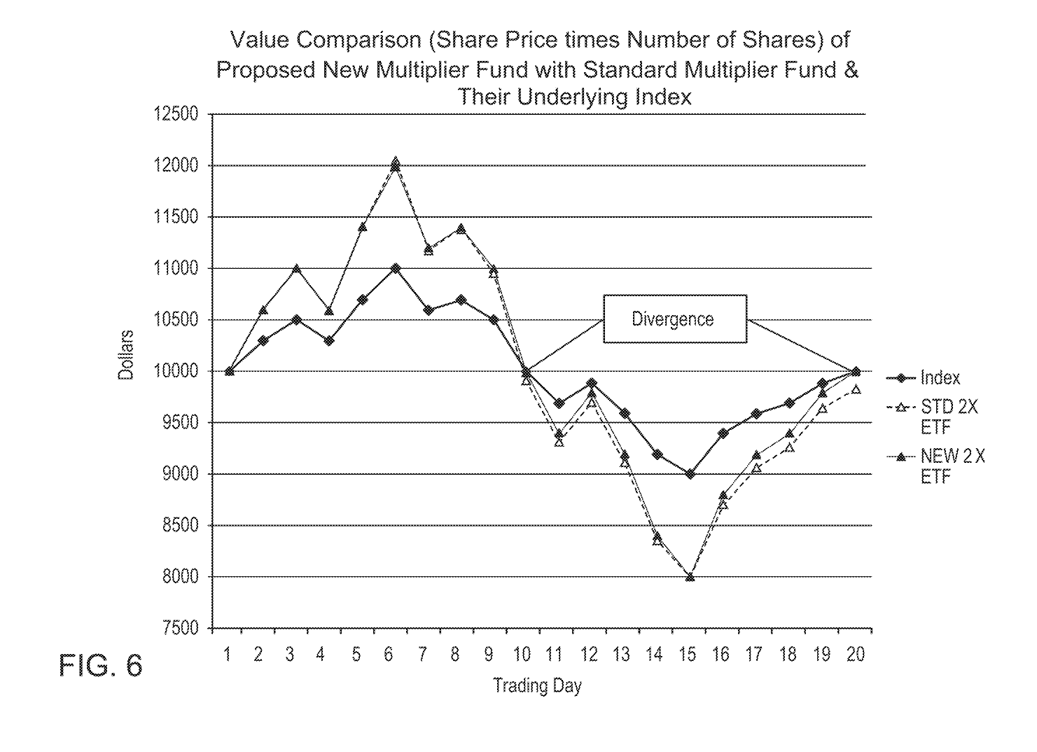

FIG. 6 is a time-series value chart illustrating the relationship between an index, a first, traditional 2× multiplier fund based on the index and a second 2× multiplier fund based on the index, the price of which is calculated using an adjustment value, according to an embodiment. More specifically, FIG. 6 shows, for a twenty trading day period, the prices of an index, a traditional 2× multiplier fund based on the index and a 2× multiplier fund also based on the index, the price of which is calculated using an additional adjustment value variable. As shown in FIG. 6, at days 10 and 20 of the trading period, a divergence exists between the prices of the underlying index and the first (traditional) 2× multiplier fund. As also shown in FIG. 6, no such divergence exists between the prices of the underlying index and the second 2× multiplier fund at the time period. As discussed in connection with FIG. 3 above, this lack of divergence between the prices of the underlying index and the second 2× multiplier fund is due to a determination of the second 2× multiplier fund price using an adjustment variable Φ.

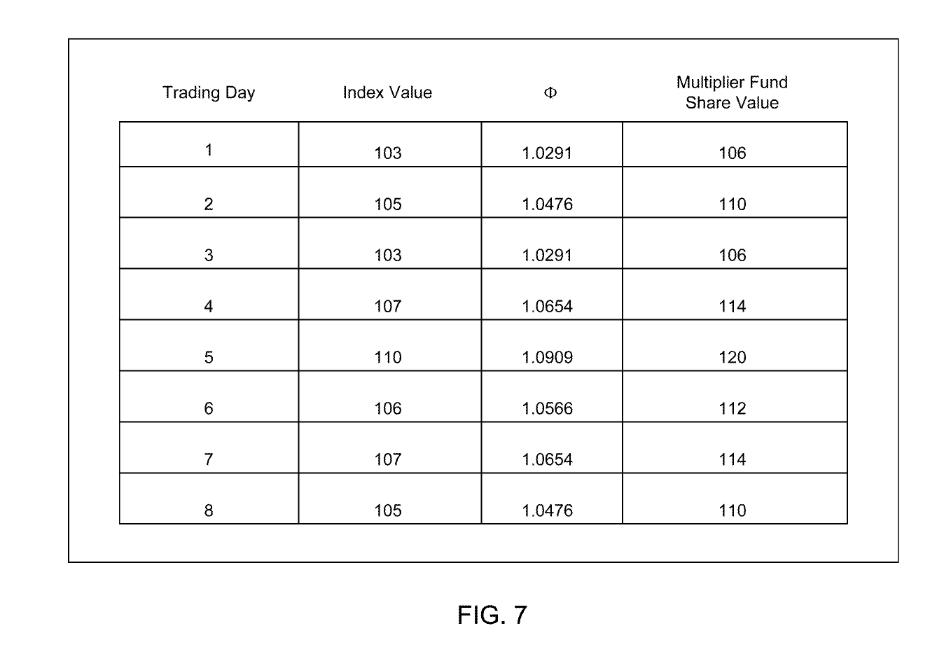

FIG. 7 is a table illustrating sample closing values of an underlying index, the corresponding value Φ for a 2× multiplier fund and the share price of the 2× multiplier fund based on the underlying index, according to an embodiment. More specifically, FIG. 7 displays a listing of an example time series demonstrating how the underlying index value, the value Φ and the share price of the 2× multiplier fund correlate over the course of eight trading days. As can be seen in FIG. 7, each daily change in the share value of the 2× multiplier fund is exactly twice that of the underlying index fund on which it is based.

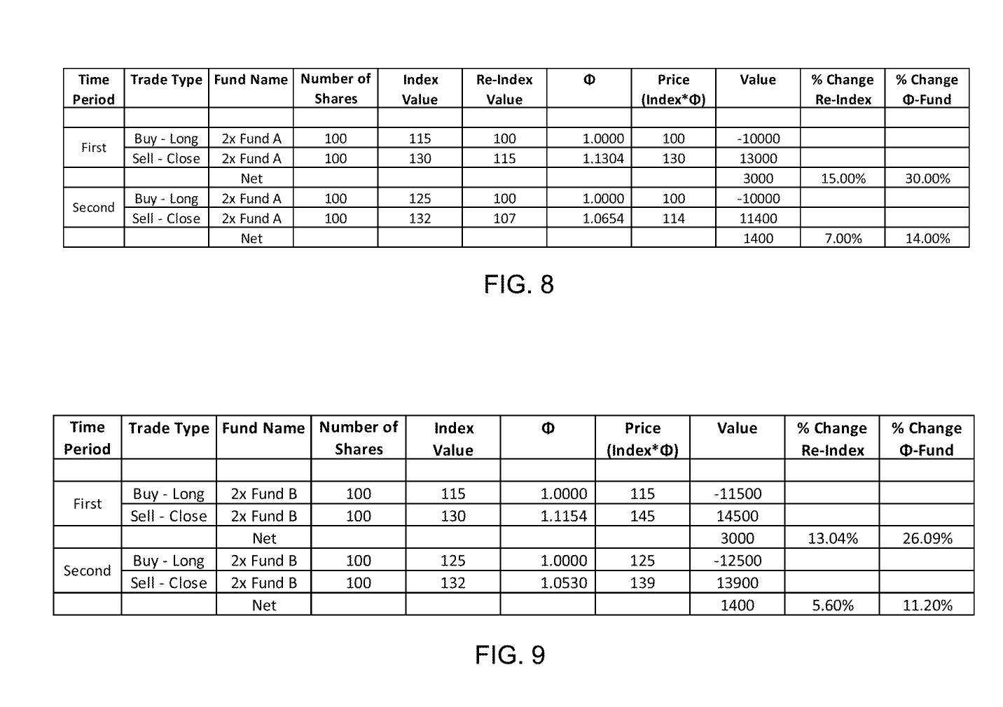

As described above, in some embodiments, it can be desirable to re-index the value of an underlying index to a predetermined value. For example, FIG. 8 is a table illustrating two sample opening and closing transactions for a 2× multiplier fund during a first time period and during a second time period, respectively, according to an embodiment. An opening transaction of “2× Fund A” includes buying 100 shares (e.g., 100 units of an asset) of the 2× multiplier fund at a first time during the first time period. Similarly stated, the valuation module 324 (FIG. 3) can receive a signal associated with the request for the current value of an asset. In other embodiments, the opening transaction can be selling a quantity of shares of the 2× multiplier fund (e.g., a “short” sale).

As shown in FIG. 8, the current index value (e.g., the index value at the time of the opening transaction) is 115. In such embodiments, the current index value of 115 is re-indexed to a re-indexed value of 100. In this manner, the opening transaction of “2× Fund A” (e.g., the buying or the guarantee to buy) substantially corresponds to an investment on the last 100 points of the underlying index (i.e., points 16-115 of the underlying index). Furthermore, by re-indexing the underlying index to 100, subsequent changes in the underlying index can be tracked as a nominal change in the underlying index. Similarly stated, by re-indexing the underlying index to 100, a percentage change in the underlying index is equal to a nominal change in the index. Thus, “2× Fund A” can function similarly to known call options (e.g., the value is associated with the portion of the investment that is “in the money”).

As shown, the adjustment value Φ at the time of the opening transaction is 1.0000. Expanding further, at the time of the opening transaction, the previous value of the index is considered to be equal to the current value of the index. Therefore, using the formula described above, the value of Φ is calculated as Φ=[100*(1+(((100−100)*2)/100))]/100. Thus, the price of an asset is calculated (value*Φ) as 100 and the cost of the opening transaction is 10000 (shown as −10000 to represent expenditure).

A closing transaction of “2× Fund A” includes selling the 100 shares of the 2× multiplier fund at a second time after the first time, during the first time period. As shown in FIG. 8, the current index at the time of the closing transaction is 130. Thus, the index value positively changed 15 points from the first time (i.e., the opening transaction) to the second time (i.e., the closing transaction). Furthermore, the 15 point change of the index value results in a 15 point change in the re-indexed value of the index (e.g., the re-indexed value increases from 100 points to 115 points).

Referring back to the formula described above, the value of the adjustment value Φ can be calculated at the second time as expressed by Φ=[100*(1+(((115−100)*2)/100))]/115. Thus, the value of Φ is 1.1304, as shown in FIG. 8, and the price of the asset at the second time is found to be 130, resulting in a value of 13000.

The change in the value of the 100 shares of the asset results in a net profit of 3000. By investing in a 2× multiplier fund, the change in the 2× multiplier fund changed by 30% while the re-indexed underlying value changed by 15%. Similarly stated, the nominal change in value of the index was 15 points which resulted in a 30 point change in the value of the 2× multiplier fund. As described above, the re-indexing of the underlying index to 100 is such that the nominal change in the re-indexed value is equal to the percent change in the re-indexed value. Therefore, the 15 point change (i.e., a 15% change) in the re-indexed value is equal to a 30 point change (i.e., a 30% change) in the 2× multiplier fund.

The second opening and closing transactions of the same 2× multiplier fund, “2× Fund A,” during the second time period are shown for example in FIG. 8 to illustrate the method described above using different opening and closing values (e.g., different values at a third time, associated with the second opening transaction, and fourth time, associated with the second closing transaction). As shown, “2× Fund A” results in a change in an asset value that is exactly twice the change in an index value. Therefore, the method of determining the values associated with “2× Fund A” is not further described herein.

In some embodiments, FIG. 8 can be, for example, a table included in an accounting system (e.g., as presented by, for example, the reporting module 326 shown in FIG. 3). In such embodiments, current accounting systems can be modified to represent the columns associated with the “Re-Index Value” and “Φ”. In this manner, minimal changes need be made to an existing accounting system to represent the added variable Φ.

In some embodiments, it can be desirable to leverage the full percentage change in an underlying index by not re-indexing the value of the underlying index to a predetermined value. In such embodiments, the full value of the holdings (e.g., investments) varies with the underlying index. For example, in some embodiments, the valuation module 324 (FIG. 3) can determine a value of a multiplier fund based at least in part on (1) a current value of the underlying index; (2) an initial value of the underlying index; (3) a multiplier of the multiplier fund (e.g., 2×, 3×, −2×, −1×, etc.); (4) and an adjustment value (referred to hereinafter as Φ). In such embodiments, to determine the value of Φ, the valuation module 324 can perform the following operation:

Φ=[((1−M)*IV_{Index})+(CV_{Index}*M)]/CV_{Index}

where IV_{Index} represents the value of the underlying index at the time of an initial opening transaction, CV_{Index} represents the current value of the underlying index, M represents the multiplier for the multiplier fund and Φ represents the adjustment value.

FIG. 9 is a table illustrating two sample opening and closing transactions for a second 2× multiplier fund during a first time period and during a second time period, respectively, according to an embodiment. An opening transaction of “2× Fund B” includes buying 100 shares (e.g., 100 units of an asset) of the second 2× multiplier fund at a first time during the first time period. Similarly stated, the valuation module 324 (FIG. 3) can receive a signal associated with the request for the current value of an asset. In other embodiments, the opening transaction can be selling a quantity of shares of the second 2× multiplier fund (e.g., a “short” sale).

As shown in FIG. 9, the current index value is 115 and the adjustment value Φ at the first time of the opening transaction is 1.0000. Expanding further, at the first time (i.e., the opening transaction), the initial value of the index is equal to the current value of the index. Therefore, using the formula described above, the value of Φ is calculated as Φ=[((1−2)*115)+(115*2)]/115. Thus, the price of an asset is calculated (value*Φ) as 100 and the cost of the initial opening transaction is 11500 (shown as −11500 to represent expenditure).

A closing transaction of “2× Fund B” includes selling the 100 shares of the first 2× multiplier fund at a second time after the first time, during the first time period. As shown in FIG. 9, the current index at the second time (e.g., the closing transaction) is 130. Thus, the index value positively changed 15 points from the first time (i.e., the initial opening transaction) to the second time (i.e., the closing transaction). Therefore, the value of the adjustment value Φ can be calculated at the second time as expressed by Φ=[((1−2)*130)+(115*2)]/130. Thus, the value of Φ is 1.1154, as shown in FIG. 9, and the price of the asset at the second time is found to be 145, resulting in a value of 14500.

The change in the in the value of the 100 shares of the asset results in a net profit of 3000. By investing in a 2× multiplier fund (“2× Fund B”), the change in the 2× multiplier fund changed by 26.09% while the underlying value changed by 13.04%. Thus, the percentage change of the 2× multiplier fund is twice the percentage change in the value of the underlying index and the full percentage change of the index can be leveraged. Furthermore, by leveraging the full percentage change in the underlying index (e.g., not re-indexing the underlying index to 100) it can be desirable to independently track each initial opening transaction (e.g., via the valuation module 324 and/or the reporting module 326 shown in FIG. 3). Similarly stated, by associating the adjustment value Φ with a value of the underlying index at a time of an opening transaction, the value of an asset is dependent on the value of the asset at the time of the opening transaction. Thus, it is desirable to independently track each opening transaction.

The second opening and closing transactions of the same 2× multiplier fund, “2× Fund B,” during the second time period are shown for example in FIG. 9 to illustrate the method described above using different opening and closing values (e.g., different values at a third time, associated with the second opening transaction, and a fourth time, associated with the closing transaction). As shown, “2× Fund B” results in a change in an asset value that is exactly twice a change in the index value. Therefore, the method of determining the values associated with “2× Fund B” is not further described herein.

While the adjustment value Φ and the price of the “2× Fund A” described above with reference to FIG. 8 is different than the adjustment value Φ and the price of “2× Fund B” described above with reference to FIG. 9, the net change (e.g., the profit) is the same. In this manner, with sufficient transparency (e.g., disclosing the adjustment value), the use of the adjustment value Φ described in reference to FIG. 8 and the use of the adjustment value Φ described in reference to FIG. 9 are each suitable to describe a value of an asset as V_{Fund}=CV_{Index}*Φ. Furthermore, in some embodiments, the equation for the adjustment value Φ described with reference to FIG. 9 can be used in, for example, a method similar to that described in FIG. 8 (e.g., wherein the underlying index is re-indexed to 100).

In some embodiments, the investments described herein (e.g., with reference to FIGS. 6-8) can be hedged by a fund manager or a counter-party with the purchase of a secondary asset. For example, in some embodiments, it is desirable for a fund manager or counter-party to limit the risk exposure of selling shares in a fund by collateralizing the investment by purchasing a secondary asset in a similar financial instrument, a different financial instrument, or combination thereof. Furthermore, in some embodiments, it can be desirable to adjust an existing collateral hedging strategy such that the hedging strategy accounts for the addition of the adjustment value Φ. Similarly stated, by associating the value of an asset with both the value of an underlying index and an adjustment value Φ, in some embodiments, a hedging strategy that is associated with the value of the underlying index and the adjustment value Φ can be implemented to provide equal exposure to both the investment and the secondary asset.

In some embodiments, a collateral hedging strategy for a standard 2× multiplier fund can include the purchase of, for example, two “deep-in-the-money” call options. In such embodiments, the call options can be purchased for a premium (e.g., a price of the option) substantially lower than the market value of the asset with a “strike price” that is also substantially lower than the market value of the asset. In such embodiments, a change in the value of the asset can result in a near dollar-for-dollar change in the value of the 2× multiplier fund and the call option as the purchaser can buy the asset at an agreed price from the seller of the call option and subsequently sell the asset to a secondary buyer at a price higher than the strike price. Thus, the exposure of the fund manager or the counter-party closely parallels that of the 2× multiplier fund shares.

In some embodiments, a method of hedging the collateral of a multiplier fund, wherein the value of the asset is partially associated with an adjustment value Φ, can include purchasing a secondary asset to mirror the exposure of the shares of the multiplier fund. For example, in some embodiments, when an investor purchases a first asset of shares of a 2× Φ-fund for $100 with a Φ-value of 1.0, the fund manager or counter-party can purchase a second asset configured to mirror the exposure of the first asset (i.e., the purchased shares). In some embodiments, the method can be such that the valuation module 324 (FIG. 3) can receive a signal associated with a request for the current value of the fund shares and a second collateral asset). In some embodiments, the second collateral asset can be, for example, one or more call options associated with an underlying index fund. In other embodiments, the second collateral asset can be one or more of an option (e.g., a put option, an option spread, an option straddle, an option box spread, an option strangle, etc.), a commodity (e.g., a futures contract, a commodity pool contract, a forward contract, a spot contact, etc.), or any other financial instrument (e.g., other mutual fund, ETF, bill, note, bond, equity, swap, etc.). In some embodiments, the number of options (e.g., call options) can be associated with the multiplier of the Φ-fund (e.g., 100 shares of a 2× Φ-fund can be hedged by two call options for 100 shares each). For example, in some embodiments, with the shares of the underlying index fund at 100, the second asset can include two call options in the underlying index fund each purchased at $30 (plus a premium value) with a strike price of $70 (e.g., deep-in-the-money call options). In other embodiments, the number of options (or other financial instrument(s)) need not be associated with the multiplier of the Φ-fund.

In some embodiments, the method employed by the fund manager or the counter-party for hedging the exposure of the multiplier fund can include adjusting the value of the second asset (e.g., purchasing more or less of the second asset) such that a similar level of exposure is maintained. Expanding further, in some embodiments, the value of the second asset can be based at least partially on the closing value of the adjustment value Φ for the previous day. For example, if the closing value of Φ is low (e.g., less than 1.0), the value of the second asset that is held can be increased and if the closing value of Φ is high (e.g., greater than 1.0), the value of the second asset that is held can be decreased. For example, in some embodiments, the 2× Φ-fund can close with a value of $110 and with a Φ-value of 1.1. Furthermore, the value of the call options (described above) can increase from $30 to $40 (plus a relatively small premium). Thus, with the value of the 2× Φ-fund increasing to $110, the value of the second asset can be reduced such that the same level of exposure is maintained. In some embodiments, the method for hedging the multiplier fund can include dividing the number of the second asset by the closing value of Φ from the previous day. For example, as described above, the closing value of Φ is 1.1, therefore, the number of call options of the second asset can be divided by 1.1 (e.g., 20/1.1=18). In some embodiments, dividing the number of call options (i.e., the second asset) can result in a portion (e.g., a fraction) of a call option. In some embodiments, the portion of the call option can be rounded such that fund manager or counter-party holds complete call options. For example, in some embodiments, if a fund manager can holds 2 call options and the Φ-value is 1.1, then 2/1.1=1.8. In such embodiments, the 0.8 portion of the call option can be rounded up such that the fund manager retains 2 complete call options. In other embodiments, one or more of the call options can be sold and a third call option of lesser exposure can be purchased. For example, in some embodiments, the 0.8 portion of the call option can be a complete call option contract worth 0.8 the exposure of the call option of the second asset such that the fund manager or counter-party holds 2 complete call options, one worth 0.8 the exposure of the other.

In some embodiments, a first asset can be associated with a first multiplier fund (associated with an underlying index) and the second asset can be associated with a second multiplier fund (associated with the underlying index) that is, for example, an inverse multiplier fund. For example, the first asset can be associated with a 2× multiplier fund (e.g., a multiplier fund that uses an adjustment value such as Φ) and the second asset can be associated with an −2× multiplier fund (e.g., a multiplier fund that uses an adjustment value such as Φ). With each multiplier fund being associated with the same underlying index, the change in value of the second asset is inversely proportional to the change in value of the first asset. Thus, if a fund manager holds a similar quantity of the first asset and the second asset, the first asset and the second asset create a balanced hedge wherein, the value of the quantity of the first asset offsets (e.g., balances, negates, equalizes, replicates, etc.) the exposure of the quantity of the second asset. In other embodiments, the fund manager can hold a first quantity of the first asset and a second quantity, less than the first quantity, of the second asset. In such embodiments, the fund manager or counter party need only hedge a portion of the quantity of the first asset that is not offset by the quantity of the second asset (or vice versa).

In some embodiments, the second asset can include, for example, put options. In such embodiments, the second asset can limit the risk of, for example, an inverse multiplier fund. While a specific collateral hedging strategy is described above, any existing hedging strategy can be modified to account for the adjustment value Φ. Expanding further, for any collateral hedging strategy in which a value of an asset is used to mirror the exposure of a standard multiplier index fund (e.g., a fund that does not use the adjustment value Φ), the value of the asset can be regulated by dividing by a factor such as Φ to provide the same level of exposure for a similar multiplier index fund that uses the adjustment value Φ. By dividing by Φ, the exposure level of a multiplier fund that uses Φ can be the same as the exposure level of a standard multiplier fund.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, in some embodiments, the valuation server can be physically and/or operatively coupled to one or more other valuation servers of a valuation system.

What is claimed is:

1. A non-transitory processor-readable medium storing code representing instructions to be executed by a processor, the code comprising code to cause the processor to:
receive a signal associated with a quantity of an asset at a first time, the asset having a value of an underlying index at the first time;
re-index the value of the underlying index at the first time to a predetermined value to produce a re-indexed value of the underlying index at the first time;
calculate a value of the asset at a second time, after the first time, based at least in part on:
the re-indexed value of the underlying index at the second time, and
an adjustment value based at least in part on:
the re-indexed value of the underlying index at the first time,
the re-indexed value of the underlying index at the second time, and a multiplier; and
send, to a requesting entity, the value of the asset at the second time.

2. The non-transitory processor-readable medium of claim 1, wherein the adjustment value is associated with the re-indexed value of the underlying index at the second time.

3. The non-transitory processor-readable medium of claim 1, wherein the underlying index is one of (1) a security, (2) a commodity, or (3) a relationship between a plurality of securities or commodities.

4. The non-transitory processor-readable medium of claim 1, wherein the predetermined value is associated with a portion of underlying index.

5. The non-transitory processor-readable medium of claim 1, wherein the re-indexed value of the underlying index at the first time is less than the value of the underlying index at the first time.

6. The non-transitory processor-readable medium of claim 1, wherein the re-indexed value of the underlying index at the first time is greater than the value of the underlying index at the first time.

7. The non-transitory processor-readable medium of claim 1, wherein:
the asset includes one or more shares of a leveraged multiplier fund; and
the multiplier is associated with the leveraged multiplier fund.

8. A method, comprising:
receiving a signal associated with an opening transaction of a quantity of an asset at a first time, the asset having a value related to an underlying index at the first time;
calculating a value of the asset at a second time, after the first time, based at least in part on:
a value of the underlying index at the second time, and
an adjustment value based at least in part on:
the value of the underlying index at the first time,
the value of the underlying index at the second time, and a multiplier; and
sending, to a requesting entity, the value of the asset at the second time.

9. The method of claim 8, wherein the underlying index is one of (1) a security, (2) a commodity, or (3) a relationship between a plurality of securities or commodities.

10. The method of claim 8, wherein:
the asset includes one or more shares of a leveraged multiplier fund; and
the multiplier is associated with the leveraged multiplier fund.

11. A method, comprising:
receiving a signal associated with a quantity of a first asset at a first time, the first asset having a value based on an underlying index at the first time;
receiving a signal associated with a quantity of a second asset at the first time, the second asset having a value configured to mirror an exposure of the first asset at the first time;
calculating an adjustment value based at least in part on:
the value of the underlying index at the first time,
a value of the underlying index at a second time before the first time, and
a multiplier;
calculating a quantity of the second asset at a third time after the first time, the value of the second asset configured to mirror an exposure of the first asset at the third time, the quantity of the second asset at the third time based at least in part on:
the quantity of the second asset at the first time, and
the adjustment value at the first time; and
sending to a requesting entity, the quantity of the second asset at the third time.

12. The method of claim 11, wherein the underlying index is one of (1) a security, (2) a commodity, or (3) a relationship between a plurality of securities or commodities.

13. The method of claim 11, wherein:
the first asset includes one or more shares of a leveraged multiplier fund; and
the multiplier is associated with the leveraged multiplier fund.

14. The method of claim 11, wherein:
the quantity of the first asset at the third time is a first quantity, the first asset being associated with a first multiplier;
the quantity of the second asset at the third time is a second quantity, less than the first quantity, the second asset being associated with a second multiplier, the second multiplier being inversely associated with the first multiplier;
the quantity of the second asset is configured to offset at least a portion of the exposure of the quantity of the first asset;
the method further comprising:
calculating a quantity of a third asset, the quantity of the third asset configured to replicate the exposure of a portion of the quantity of the first asset at the third time not offset by the quantity of the second asset at the third time.

15. The method of claim 11, wherein at least a portion of the second asset is a call option.

16. The method of claim 11, wherein at least a portion of the second asset is a set of call options, a number of call options included in the set of call options is at least partially associated with the multiplier.

17. The method of claim 11, wherein at least a portion of the second asset is a put option.

18. The method of claim 11, wherein at least a portion of the second asset is a set of put options, a number of put options included in the set of put options is at least partially associated with the multiplier.

19. The method of claim 11, wherein at least a portion of the second asset is a futures contract.

20. The method of claim 11, wherein at least a portion of the second asset is a set of futures contracts, a number of futures contracts included in the set of futures contracts is at least partially associated with the multiplier.

21. The method of claim 11, wherein at least a portion of the second asset is a commodities contract.

22. The method of claim 11, wherein at least a portion of the second asset is a set of commodities contracts, a number of commodities contracts included in the set of commodities contracts is at least partially associated with the multiplier.

23. The method of claim 11, wherein at least a portion of the second asset is a forward contract.

24. The method of claim 11, wherein at least a portion of the second asset is a set of forward contracts, a number of forward contracts included in the set of forward contracts is at least partially associated with the multiplier.
